(19) United States
(12) Patent Application Publication
(10) Pub. No.: US 2007/0083545 A1
(43) Pub. Date: Apr. 12, 2007

(54) Selectively triggering events

(76) Inventor: Erwin Pinter, Speyer (DE)

Correspondence Address: FISH & RICHARDSON, P.C., PO BOX 1022, MINNEAPOLIS, MN, 55440-1022, US

(21) Appl. No.: 11/249,805

(22) Filed: Oct. 12, 2005

(51) Int. Cl. G06F 7/00

(52) U.S. Cl. 707/102

(57) ABSTRACT

A modification of at least one attribute of a database object may be associated with one of a plurality of classification nodes defined by a hierarchical tree. Such classification nodes may classify or otherwise categorize modifications to attributes of the database object. At least one of the classification nodes may correspond to an event trigger such that if the associated classification node has an ancestor classification node in the hierarchy tree corresponding to at least one event trigger, an event is triggered that is operable to initiate one or more transactions associated with the database object.

### TECHNICAL FIELD

The subject matter described herein relates to the selective triggering of events in response to a modification of an attribute of a database object.

### BACKGROUND

Data warehouses are increasingly storing large numbers of attributes associated with database objects. Such database objects may represent physical or logical objects of significance to a business (e.g., a business object). In some scenarios, the modification of such database objects may trigger one or more events. For example, depending on which aspects of the database object are modified, events such as alerting one or more entities to a change in the price of goods or other changes associated with the database object (e.g., temperature of device, availability of raw materials, security breach, etc.) may be transmitted via e-mail or otherwise conveyed to one or more entities. When a large number of attributes are associated with a database object, efficiently and rapidly categorizing which attribute modifications should trigger a subsequent event requires an understanding of the context of such modifications.

With modifications to a database object that are characterized with a rough granularity (i.e., the modification is generic in nature), the importance of such modifications often need to be evaluated separately based on their context. For example, if a modification to an attribute is characterized as a “contract change”, the information relevant to the change must be examined (e.g., the price of the contract has changed, etc.). Therefore, if a modification is too broadly defined, more events may be triggered than are necessary.

In contrast, with modifications to a database object that are characterized with a fine granularity (i.e., the modification is semantic in nature), the result of such modifications may sometimes be determined from such characterization. For example, the characterization “price of contract has changed” identifies that the price of the contract has changed. However, in some situations, this characterization may not provide sufficient detail to identify the modifications to the database object. Moreover, in a large enterprise, there may be frequent modifications to attributes of database objects, and if such modifications are characterized with a fine granularity, an overwhelming number of events may be unnecessarily triggered.

### SUMMARY

In one aspect, a computer-implemented method may associate a modification of at least one attribute of a database object with one of a plurality of classification nodes defined by a hierarchical tree. Such classification nodes may classify modifications to attributes of the database object and at least one of the classification nodes may correspond to at least one event trigger. If the associated classification node has an ancestor classification node in the hierarchy tree corresponding to at least one event trigger, an event corresponding to the event trigger may be initiated. Such an event, after being triggered, may be operable to initiate one or more transactions associated with and/or that use the database object.

The trigger of an event may, include transmitting data (e.g., an e-mail message, etc.) identifying the modification of the at least one attribute of the database object via a communications network. For example, an e-mail message may be sent to an entity that is required to approve certain modifications to a database object attribute.

Each node in the hierarchy tree may have an associated granularity which relates to the specificity of the corresponding database object attributes for such node. In some variations, these granularities may be used to identify one of a plurality of classification nodes having a finest granularity. In other words, only the classification node which most specifically relates to the modified attribute should be associated with the modification. Granularity may be manually assigned or it may be automatically determined based on a number of descendant nodes for each node. In addition, the granularities for the classification may be used to assign each node having a granularity less than a predetermined level with an event trigger.

The hierarchy tree may be generated in a variety of manners. If classification nodes do not characterize modifications to attributes with sufficient specificity, new children nodes may be generated from pre-existing classification nodes. In one variation, at least one refinement condition is defined based on a portion of a modifications classified by a first node. A child node may be generated dependent on the first node such that the child node classifies modifications to attributes based on the at least one refinement condition. Optionally, if the nodes of the hierarchy tree characterize modifications to the attributes in too much detail, at least two nodes in the hierarchy tree may be merged to form a combined node, the combined nodes classifying modifications to attributes previously classified by the at least two merged nodes.

In another aspect, an apparatus may comprise an association unit and an initiation unit. The association unit may be operable to associate a modification of at least one attribute of a database object with one of a plurality of classification nodes defined by a hierarchical tree. Such classification nodes may classify or otherwise categorize modifications to attributes of the database object. At least one of the classification nodes may correspond to at least one event trigger. The initiation unit is operable to trigger an event if the associated classification node has an ancestor classification node in the hierarchy tree corresponding to at least one event trigger. The triggered event may be operable to initiate one or more transactions associated with and/or that use the database object. Optionally, the apparatus may include or be couple to a data repository for storing attributes associated with the database object.

In some variations, the initiation unit may trigger an event if the associated classification node corresponds to at least one event trigger and/or the apparatus may further comprise a transmitter to transmit data identifying the modification of the at least one attribute of the database object via a communications network in response to the initiation unit triggering an event.

The association unit may associate a granularity with each node in the hierarchical tree. Based on these granularities, the association unit may identify one of a plurality of classification nodes associated with the modified attribute as having a finest granularity. Granularity may be defined based on a variety of criteria such as a number of descendants for each node. Optionally, the association unit may associate each node having a granularity less than a predetermined level with an event trigger.

The apparatus may comprise a node generation unit that may be operable to define at least one refinement condition based on a portion of a modifications classified by a first node. The node generation unit may additionally be operable to generate a child node dependent on a first node, the child node classifying modifications to attributes based on the at least one refinement condition and/or to merge at least two nodes in the hierarchy tree to form a combined node, the combined nodes classifying modifications to attributes previously classified by the at least two merged nodes.

In an interrelated aspect, a modification of at least one attribute of a database object may be associated with one of a plurality of classification nodes defined by each of a plurality of hierarchical trees. Such classification nodes may classify modifications to attributes of the database object. In addition, at least one classification node for each of the plurality of hierarchical trees may correspond to at least one event trigger. Thereafter, for each of the plurality of hierarchical trees, at least one event may be triggered if the associated classification node has an ancestor classification node in the hierarchy tree corresponding to at least one event trigger. Each of these events may be operable to initiate one or more transactions using the modified characteristic of the database object.

Computer program products, tangibly embodied in information carriers are also described. Such computer program products may cause a data processing apparatus to conduct one or more operations described herein.

Similarly, systems are also described that may include a processor and a memory coupled to the processor. The memory may encode one or more programs that cause the processor to perform one or more of the method acts described herein.

The subject matter described herein provides many advantages. For example, the current subject matter allows for certain selected modifications to database object attributes to trigger events thereby permitting optimizing a number of events to be initiated.

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

FIG. 1 is a process flow diagram of a method for determining whether a modification to a database object triggers an event;

FIG. 2 is a schematic diagram of an apparatus to determine whether a modification to a database object triggers an event; and

FIG. 3 is an illustration of a sample hierarchy tree.

Like reference symbols in the various drawings indicate like elements.

### DETAILED DESCRIPTION

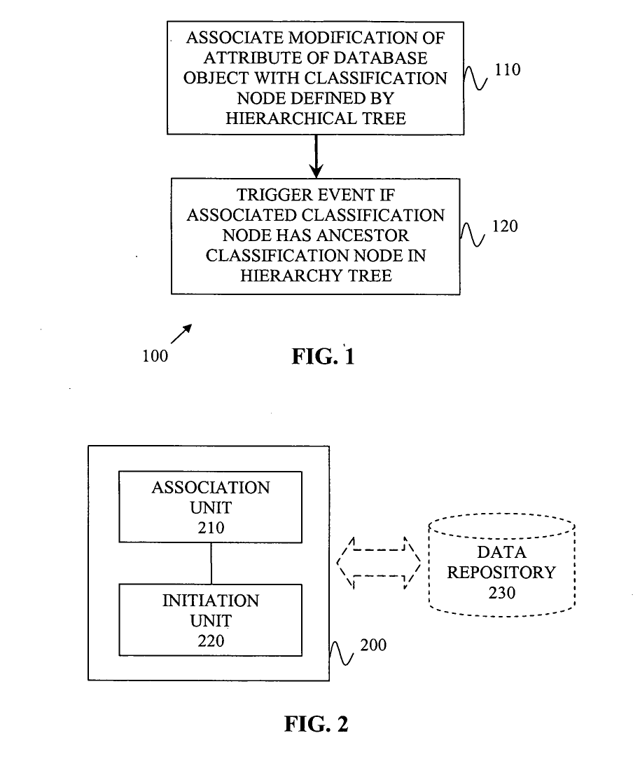

FIG. 1 is a process flow diagram illustrating a method 100, which at 110, associates a modification of at least one attribute of a database object (whether persisted in a database or otherwise) with one of a plurality of classification nodes defined by a hierarchical tree. Such classification nodes classify modifications to attributes of the database object and at least one of such classification nodes corresponds to at least one event trigger. An event is triggered, at 110, if the associated classification node has an ancestor classification node in the hierarchy tree corresponding to at least one event trigger. Such an event may be operable to initiate one or more transactions associated with and/or that use the modified characteristic of the database object.

FIG. 2 illustrates an apparatus 200 that comprises an association unit 210 and an initiation unit 220. The association unit 210 is operable to associate a modification of at least one attribute of a database object with one of a plurality of classification nodes defined by a hierarchical tree. These classification nodes classify modifications to attributes of the database object and at least one of the classification nodes corresponds or is otherwise associated with at least one event trigger. The initiation unit 220 is operable to trigger an event if the associated classification node has an ancestor classification node in the hierarchy tree corresponding to at least one event trigger. Such an event may be operable to initiate one or more transactions associated with and/or using the modified characteristic of the database object. In some variations, the apparatus 200 may include or be coupled to a data repository 230 which stores the attributes associated with the database object and/or which optionally provides an indication of which attributes associated with the database object have been modified.

The following provides information useful for understanding and implementing the subject matter described herein as well as optional variations that may be implemented singly or in combination depending on the desired configuration.

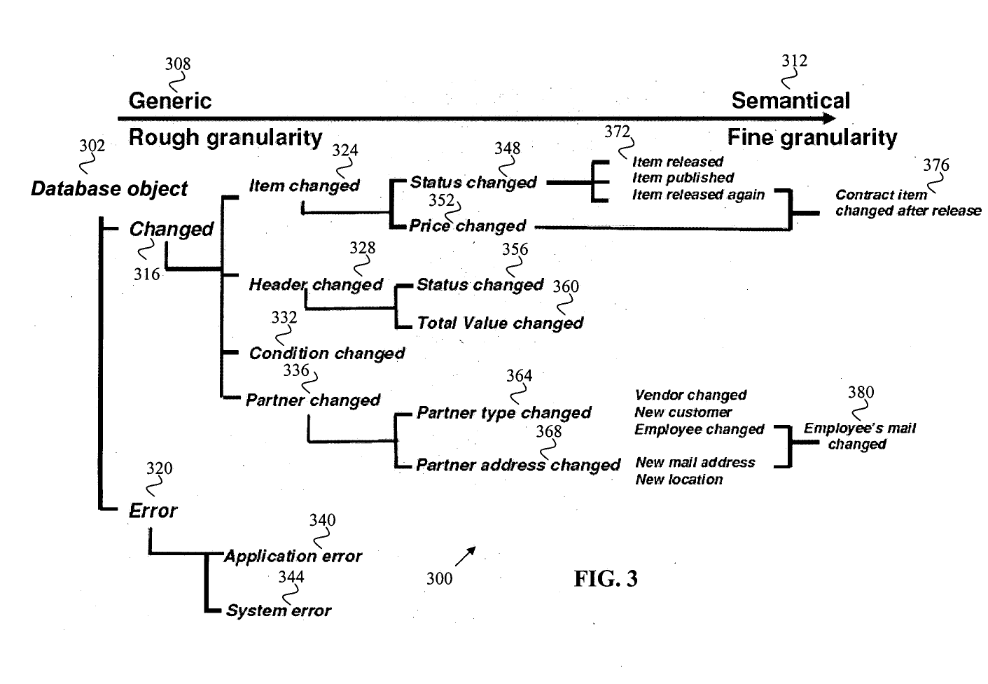

FIG. 3 illustrates a sample hierarchy tree 300 with a root node 302 associated with a database object. This hierarchy tree 300 represents the hierarchical structure of attribute modifications to a database object which may trigger one or more events. Such modifications may relate to a database object persisted in a data repository and/or modifications to a database object which have been computed and which have not been persisted to a data repository. Such a hierarchical tree 300 may comprise a connected acyclic graph. The lines connecting elements are referred to as branches in the hierarchical tree 300, the elements themselves are referred to as nodes. Nodes which depend on other nodes are referred to children and nodes without children are referred to as end-nodes or leaves. Moreover, a node is a parent of another node if it is one step higher in the hierarchy and closer to the root node, and sibling nodes shares the same parent node. A node that is connected to all lower-level nodes is referred to as an ancestor (e.g., root node 302 is an ancestor for all other nodes in the hierarchy tree 300).

As illustrated, the nodes of the hierarchy tree may range from a generic characterization (i.e., they may have rough granularity) from the root node 302 to a semantical characterization (i.e., they may have finer granularity) at one or more leave nodes 384, 388. The nodes may each correspond to an individual attribute stored in a data repository and associated with the database object or they may define a portion of one attribute and/or more than one attribute. The root node 302 may include two children nodes, namely a changed node 316 which includes children nodes 324, 328, 332, 336 which may identify modification to attributes characterizing the database object and it sibling error node 320 which may include children nodes 340, 344 that identify operation errors associated with the database object.

Item changed node 324, which may be a child node of changed node 316, may include status changed node 348 which indicates a change in status regarding the database object and price changed node 352 which indicates a change in price of an object or contract associated with the database object as children. The status changed node 348 may have a child node 372 which is associated with one or more of the following: release of an item; publishing of an item; and re-release of an item. The price changed node 352 may have a child node 384 which relates to whether a contract item has changed after release of an item. Node 376 may also be a child node to node 372 as illustrated.

Header changed node 328, which may be a child node of changed node 316, may have a status changed node 356 which relates to a status change associated with a header and a total value changed node 360 which relates to a change in a total value of an item and/or a contract associated with the database object as children. The changed node 316 may also have condition changed node 332 which identifies a change in a condition as a child node.

Partner changed node 336, which may be a child node of changed node 316 may include a child node 364 that identifies a change in partner type. Such a change in a partner type may comprise, for example, a change in a vendor, a new customer associated with the database object, a change of an employee or contact person and the like. A partner address changed node 368 may also be dependent on the partner changed node 336 and may relate to a change in a mail address, a new location, and the like. Dependent upon both of the partner type changed node 364 and the partner address changed node 368 may be an employee's mail changed node 380 which relates to a change in the contact information for an employee of a partner.

Lastly, the error node 320 may have an application error node 340 that identifies an error that has occurred in an application associated with the database object and a system error node 344 that identifies whether an error has occurred in the operation of a system associated with the database object. It will be appreciated that the illustrated hierarchy tree 300 may comprise any variety of nodes depending on a database object for which attributes may be modified and the desired granularity. In some variations, the hierarchy tree 300 may be based on a data structure in which various attributes of a database object are stored and/or generated. For example, each node may correspond to a single attribute for a database object that is stored in the database repository.

One or more nodes of the hierarchy tree 300 may be associated with one or more event triggers so that a modification to an attribute of the database object (as provided by a data repository or a monitoring unit coupled to the data repository) that has a node corresponding to such event triggers may result in the initiation of an event. Such an event trigger may include the initiation of an alert or e-mail message in response to a change in the database object 302. For example, each of nodes 348, 352, 356, 360, 364, and 368 may be associated with one or more event triggers. With such an arrangement, if there are any modifications to attributes associated with the database object 302 which have a finer granularity than such nodes, one or more events may be triggered. In some variations, both nodes 348, 352, 356, 360, 364, and 368 their respective descendant nodes each may correspond to an event trigger.

Each branch of nodes 348, 352, 356, 360, 364, and 368 may be associated with a single event trigger (although it will be appreciated that each branch may be associated with multiple event triggers and each node in the branches may correspond to one or more event triggers). For example, if an attribute of the database object 302 relating to the release of an object has been changed or an attribute relating to a change in a contract item after its release has been changed, nodes 372 and 384 are affected thereby resulting in the event trigger associated with ancestor node 348 to be initiated. The resulting event, for example, may comprise sending data such as an e-mail via a communication network or providing a local alert to a manager seeking approval of the item and/or contract change. Other events might include updating a second database object to reflect the change in the attribute of database object 302, shutting down or otherwise altering the operations of a remote system associated with database object 302 (e.g., shut down remote system in case of security breach or if temperature within reaction chamber exceeds a predetermined level, etc.),

The nodes within the hierarchy tree 300 may be associated with event triggers manually by an administrator or automatically using, for example, criteria associated with such nodes. For example, each node may be associated with a granularity. In some cases, this granularity may be based on a number of nodes descending from each such node and/or the number of nodes depending from each such node. With this configuration, the rougher granularity nodes have more descendants and the finer granularity nodes have fewer, if any, descendants.

The nodes on the hierarchy tree 300 may be manually configured or in some cases, they may be automatically configured. After a certain number of nodes have been defined, additional nodes may be generated, for example, by combining and/or splitting attribute modifications classified by pre-existing nodes. In one variation, at least one refinement condition is defined for a parent node which in turn may be used to generate a child node that classifies attribute modifications to the database object based on the refinement condition. For example, a new child node associated with contract item price changed may be generated that is dependent on a parent node associated with contract item changed using a refinement condition of field changed=price. Moreover, at least two nodes in the hierarchy tree 300 may be merged to form a combined node that classifies modifications to attributes previously classified by the at least two merged nodes.

Various implementations of the subject matter described herein may be realized in digital electronic circuitry, integrated circuitry, specially designed ASICs (application specific integrated circuits), computer hardware, firmware, software, and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and may be implemented in a high-level procedural and/or object-oriented programming language, and/or in assembly/machine language. As used herein, the term “information carrier” comprises a “machine-readable medium” that includes any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal, as well as a propagated machine-readable signal. The term “machine-readable signal” refers to any signal used to provide machine instructions and/or data to a programmable processor.

To provide for interaction with a user, the subject matter described herein may be implemented on a computer having a display device (e.g., a CRT (cathode ray tube) or LCD (liquid crystal display) monitor) for displaying information to the user and a keyboard and a pointing device (e.g., a mouse or a trackball) by which the user may provide input to the computer. Other kinds of devices may be used to provide for interaction with a user as well; for example, feedback provided to the user may be any form of sensory feedback (e.g., visual feedback, auditory feedback, or tactile feedback); and input from the user may be received in any form, including acoustic, speech, or tactile input.

The subject matter described herein may be implemented in a computing system that includes a back-end component (e.g., as a data server), or that includes a middleware component (e.g., an application server), or that includes a front-end component (e.g., a client computer having a graphical user interface or a Web browser through which a user may interact with an implementation of the subject matter described herein), or any combination of such back-end, middleware, or front-end components. The components of the system may be interconnected by any form or medium of digital data communication (e.g., a communication network). Examples of communication networks include a local area network (“LAN”), a wide area network (“WAN”), and the Internet.

The computing system may include clients and servers. A client and server are generally remote from each other and typically interact through a communication network. The relationship of client and server arises by virtue of computer programs running on the respective computers and having a client-server relationship to each other.

Although a few variations have been described in detail above, other modifications are possible. For example, the logic flow depicted in the accompanying figures and described herein do not require the particular order shown, or sequential order, to achieve desirable results. Other embodiments may be within the scope of the following claims.

What is claimed is:

1. A computer-implemented method comprising:
associating a modification of at least one attribute of a database object with one of a plurality of classification nodes defined by a hierarchical tree, the classification nodes classifying modifications to attributes of the database object, wherein at least one classification node corresponds to at least one-event trigger; and
triggering an event if the associated classification node has an ancestor classification node in the hierarchy tree corresponding to at least one event trigger, wherein the event is operable to initiate one or more transactions associated with the database object.

2. A method as in claim 1, further comprising:
triggering an event if the associated classification node corresponds to at least one event trigger.

3. A method as in claim 2, wherein the triggering an event comprises:
transmitting data identifying the modification of the at least one attribute of the database object via a communications network.

4. A method as in claim 1, further comprising:
associating a granularity with each node in the hierarchical tree.

5. A method as in claim 4, wherein the associating a modification of at least one attribute of a database object with one of a plurality of classification nodes defined by a hierarchical tree comprises:
identifying one of a plurality of classification nodes associated with the modified attribute having a finest granularity.

6. A method as in claim 4, wherein, for each node, granularity is based on a number of nodes descending therefrom.

7. A method as in claim 4, further comprising:
associating each node having a granularity less than a predetermined level with an event trigger.

8. A method as in claim 1, further comprising:
defining at least one refinement condition based on a portion of modifications classified by a first node; and
generating a child node dependent on the first node, the child node classifying modifications to attributes based on the at least one refinement condition.

9. A method as in claim 1, further comprising:
merging at least two nodes in the hierarchy tree to form a combined node, the combined nodes classifying modifications to attributes previously classified by the at least two merged nodes.

10. An apparatus comprising:
an association unit to associate a modification of at least one attribute of a database object with one of a plurality of classification nodes defined by a hierarchical tree, the classification nodes classifying modifications to attributes of the database object, wherein at least one classification node corresponds to at least one event trigger; and
an initiation unit to trigger an event if the associated classification node has an ancestor classification node in the hierarchy tree corresponding to at least one event trigger, wherein the event is operable to initiate one or more transactions associated with the database object.

11. An apparatus as in claim 10, further comprising a data repository for storing attributes associated with the database object.

12. An apparatus as in claim 10, wherein the initiation unit triggers an event if the associated classification node corresponds to at least one event trigger.

13. An apparatus as in claim 12, further comprising:
a transmitter to transmit data identifying the modification of the at least one attribute of the database object via a communications network in response to the initiation unit triggering an event.

14. An apparatus as in claim 10, wherein the association unit associates a granularity with each node in the hierarchical tree.

15. An apparatus as in claim 14, wherein the association unit identifies one of a plurality of classification nodes associated with the modified attribute having a finest granularity.

16. An apparatus as in claim 14, wherein the association unit determines granularity for each node based on granularity on a number of nodes descending therefrom.

17. An apparatus as in claim 14, wherein the association unit associates each node having a granularity less than a predetermined level with an event trigger.

18. An apparatus as in claim 11, further comprising:
a node generation unit to define at least one refinement condition based on a portion of modifications classified by a first node and generate a child node dependent on the first node, the child node classifying modifications to attributes based on the at least one refinement condition.

19. An apparatus as in claim 11, further comprising:
a node generation unit to merge at least two nodes in the hierarchy tree to form a combined node, the combined nodes classifying modifications to attributes previously classified by the at least two merged nodes.

20. A computer program product, tangibly embodied in an information carrier, the computer program product being operable to cause a data processing apparatus to:
associate a modification of at least one attribute of a database object with one of a plurality of classification nodes defined by each of a plurality of hierarchical trees, the classification nodes classifying modifications to attributes of the database object, wherein at least one classification node for each of the plurality of hierarchical trees corresponds to at least one event trigger; and
triggering, for each of the plurality of hierarchical trees, at least one event if the associated classification node has an ancestor classification node in the hierarchy tree corresponding to at least one event trigger, wherein the at least one event is operable to initiate one or more transactions associated with the database object.
